(19) United States
(12) Patent Application Publication
(10) Pub. No.: US 2004/0010426 A1
(43) Pub. Date: Jan. 15, 2004

(54) Target insurance

(76) Inventor: Felipe Berdou, Buenos Aires (AR)

Correspondence Address: FELIPE BERDOU, PASO 784 App 1, BUENOS AIRES, 1032, AR

(21) Appl. No.: 10/407,518

(22) Filed: Apr. 3, 2003

Related U.S. Application Data
(60) Provisional application No. 60/370,908, filed on Apr. 4, 2002.

(51) Int. Cl. G06F 17/60

(52) U.S. Cl. 705/4

(57) ABSTRACT

The invention is a computer system and method to create complementary or alternative choice to known insurance art risk coverage. Enables consumers to buy an obligation from selected suppliers legally bound to timely supply the agreed output upon claim by a beneficiary. A saving inherent to a cash or loaned prepaid obligation to self compensate a measurable event loss, in order to complement or substitute current and future expenditure of insurance premiums covering similar risks. Said obligation traded and swapped at will by consumers and suppliers in a suitable trading floor.

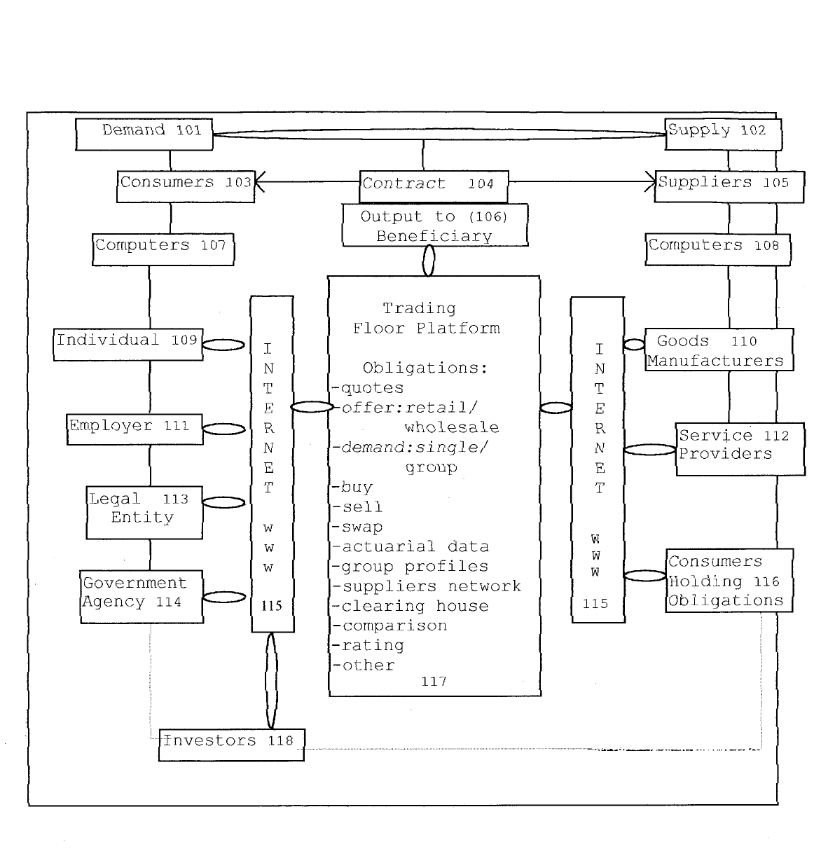

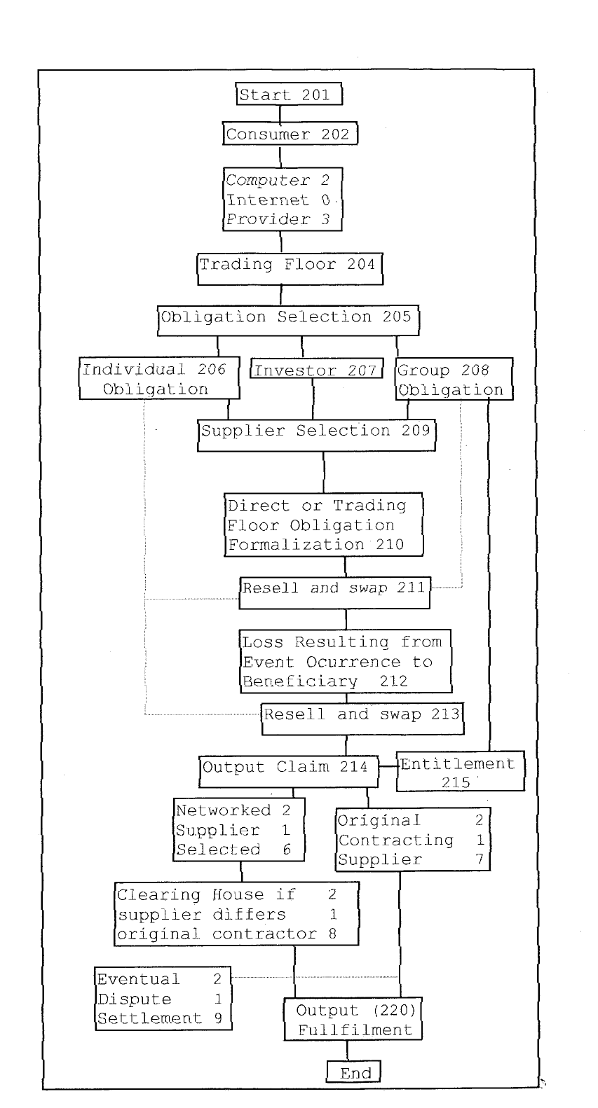

### REFERENCE TO RELATED APPLICATION

This application claims priority of U.S. provisional patent application Serial No. Nr.60/370,908, filed Apr. 4, 2002, a constituting part of the present invention, the entire contents of which is incorporated herein by reference.

### GLOSSARY

It seems convenient to clarify some terms used below:

Beneficiary: consumer entitled to claim supplier's output.

Consumer: single or grouped individuals, employers, private and/or public legal entities, government agencies, and investors able to purchase obligations.

Event: future act of God or human act.

Measurable: able to be priced as defined, specific and finite output.

Obligation: legally binding arrangement whereby, in return for agreed price, a consumer acquires a right to a supplier's specific output at future time upon claim by a beneficiary.

Output: tradable goods, services, and money amounts.

Supplier: single or grouped service provider and/or goods manufacturer.

Trading floor: physical or electronic (virtual) marketplace where obligations can be traded or swapped.

### FIELD OF THE INVENTION

This invention relates generally to a risk coverage system and method, and more specifically, to a computer system and method for complementing or substituting prior art insurance risk coverage.

### BACKGROUND OF THE INVENTION

“Insurance as a readily recognizable business first emerged in Britain at the end of the sixteenth century. The two main concerns of the pioneers over the next two hundred years were fire insurance—doubtless a reaction to such events as the Great Fire of London in 1666—and marine insurance—a reflection of Britain's prominent position in the world of sea-borne trade”. In current insurance art buyers and sellers behave in a manner in which, being the main purpose of insurance the protection from financial ruin, the insured pool insurance premiums to pay for claims and insurers (broker/agent/underwriter/co-insurer/re-insurer). The Census Bureau indirectly defines insurance as the “pooling of risk” (1).

The insured pays a premium price to cover an agreed upon loss risk that might result from an event taking place after the agreement. If a claim arises as a consequence of loss, the insured is credited the agreed compensation value that is generally redirected to the supplier able to replace the loss.

Furthermore many of the insured events will not happen. In fact the sole event that is certain to happen to everyone is death. Hence, at least partially, insurance premiums are contributions to benefit others. Were this reasoning untrue insurance companies would be financially unsustainable. “According to economic theory individuals will purchase insurance if it increases their utility. Rational, risk-averse individuals will even be willing to pay a ‘risk premium’ for insurance, i.e., they will be willing to pay a premium that exceeds their expected loss. Consequently, risk-averse individuals may be willing to participate in insurance schemes that force them to subsidize other insureds” (2).

Average male life expectancy in the United States and other developed countries is 74 years while female is 80 years (3). In a life-span a person born today might well spend paying for the most common insurance premiums, at current prices, approximately as follows:

$188,130 for automobile insurance

$236,319 for healthcare insurance

$ 78,000 medicare government expenditure

$ 77,642 for Medicare supplement insurance

$ 76,140 for house-owner insurance

$260,426 for term life insurance

$103,974 for long term care insurance

Total . . . $1,020,631.—

Automobile insurance is for a Honda Accord valued approximately in $20.000, with standard coverage for Los Angeles, Santa Monica Co, Calif., male driver with no accident record during the whole insurance period. Amount of $188,130 average (comparison lower and higher) premium, corresponds to 60 years expenditure from 3^{rd} year of driver license issuance to 63^{rd} year (4).

Healthcare insurance is average quotes of three companies, individual, healthy male, non-hazard job, PPO/POS plan, no deductible, no coinsurance, $2,000 out-of-pocket per year. Value of $236,319 corresponds to premiums paid from birth to year 65. Most expensive remaining premiums to death are not included since referred source quotations reach only year 65 (5).

Medicare spending per beneficiary in 1997 was $5,182 adding in 15 years, from age 66 to 80, $78,000 (6).

Medicare supplement insurance value of $77,642 corresponds to average (comparison lower and higher) premiums paid over a period of 15 years from age 66 to 80, for a male, plan J option (4).

House-owner insurance is for standard risks coverage for a house valued in $300,000, with no redlining location. Amount of $76,140 corresponds to 60 years premiums paid. Insurance does not cover climatic or catastrophic risks as flood or earthquake (7).

Term life insurance average quotes of two companies rated A++, for a healthy female, preferred non tobacco. Amount of $260,426 corresponds to 60 years premiums paid (lower than a male's), covering insured amount of $250,000 (7).

Long term care insurance value ($103,974) corresponds to average (comparison lower and higher) premium paid over a period of 15 years from age 66 to 80, comprehensive lifetime plan, for a male, 30 day elimination period, 5% inflation adjustment included (4).

The value of an automobile ($20,000) is 100% covered with a 10.66% of the insurance premiums paid ($188,130). Premiums money is enough to buy almost ten cars valued as the one insured or one car every six years. Most potential liability risks are also covered with the amount of premiums paid.

As noted above an American healthy male will spend up to his 65^{th} birthday $236,319 in premiums for healthcare coverage, beyond the out of pocket money due every single year. Ten percent of health care insurance is individually sold and is the only one to guarantee permanent coverage with no gaps. An average family employer health insurance expenditure in 65 years may reach $546,000 (8).

Term Life Insurance is an interesting case due to the fact that in the long run we are all dead. That's why premiums get very expensive as life expectancy limits approach. If anybody, as the person in the example, reaches or slightly survives that limit, premiums aggregation tend to exceed the compensation value.

Having in mind the pooling of risk and stressing the individual case, generally speaking Healthcare and Auto insurance, as well as House-owner, Medicare and Supplement and Long Term Care insurance, must have a lower compensation value correspondence to premiums paid. In other words pooled premiums expenditure should be larger than compensations. Many insured will only contribute expenditure with no chance to get money back.

Besides the large insureds' average expenditure common in current art insurance, there are several escalating problems that both insurers and insureds face. Some of those problems are:

Cost predictability: A conspicuous example of cost control efforts is healthcare coverage. “Many of the health care cost problems result from the fact that health care expenditures are paid for by somebody other than the user, usually an insurance company or a government organization. Indeed, 97.5% of hospital expenses are paid by someone other than the patient” (9). “The crisis of soaring health care costs has one fundamental cause: people are usually spending someone else's money when they purchase health care services. The rise of third-party payment has created an incentive structure that makes runaway spending inevitable. Health insurance is now the equivalent of auto insurance that covers fill-ups and oil changes”(10). The statements seem reasonable not only for healthcare but for the insurance industry at large. In California from 1991 to 1997 private passenger auto liability and physical damage raised from 7.4 billion to 9.2 billion, with a dramatic increase since 1997 (4) .

U.S. healthcare expenditure was 8.85% ($245.8 billion) of GDP in 1980 and 13% ($1,210.7 billion) in 1999. Per person spending was $1,067 in 1980, $4,154 in 1998 and $4,358 in 1999. In 1980 Federal Government health expenditure was 42.6% of total, in 1999 45.3% (11). It is estimated that by 2005 healthcare expenditure will be a 17.9% of GDP (12). During 1995 out of pocket money or expenditure not covered by insurance and for co-payments and deductibles was $182.6 billion equivalent to 56% of total household healthcare spending (13), in 1999 was $186.5 billion in spite of efforts to reduce it (11). Medicare expenditure per beneficiary enrolled in managed care was $4,323 in 1995, $5,182 in 1997 and $5,521 in 1999. In 1995 Americans under age 65 spent 4% of after tax income in healthcare and over age 65 a 12.5% (14).

Roughly two thirds of all 1993 health insurance claims in U.S. fell in the under $3,000 dollars per year category (10). In 1994 the average American family took $6,000 a year from employer, plus $400 deductible and $2,000 out of pocket maximum (8) (the equivalent to $84,000 every ten years). According to a 1996 survey, 82% of Americans responding wanted catastrophic health coverage (15).

Gaps in health coverage: In 1987 14.5% of the population had no health coverage, in 1999 reached 17.8% (11). According to the Census Bureau “Health insurance premiums took a sharp turn upwards in 2000 and 2001 rising an average 8% in 2000 and an average 11% in 2001. (Small businesses saw premiums rise an average 12.5% in 2001.) Overall inflation averaged 3% to 3.5% in 2000-2001. Economic theory predicts that a cost increase of 11% could reduce the number of people with private insurance by 1.1% . . . 2 million could, in theory, loose coverage . . . Growing unemployment, economic downturn and higher insurance premiums and health costs cause erotions in health insurance coverage . . . reportage and the debate both would be well served by a deeper appreciation of the number of Americans—more than one in five—who have some gap in (health) coverage over a years time. (Over three years, the number is closer to one in three Americans.)This could help focus attention on the reasons for short gaps in coverage as distinguished from long gaps. Solutions to both are important in an era when comprehensive reforms to create a system of universal coverage are politically unpalatable . . . . This trend through the 1990's has appropriately focused political attention on ways to expand health insurance coverage in the U.S. Moreover, what resonates most about this trend is that the erosion of coverage occurred during one of the most prolonged periods of economic expansion in U.S. history.” (16).

Insurance Fraud: There are 20 different insurance fraud modes in the scam glossary of the National Insurance Crime Bureau website. More than 10% property/casualty insurance claims are fraudulent. About $30 billion a year or $200/300 in higher insurance premiums for the average household is the estimated disclosed value of fraud in that insurance sector for the U.S. During economic downturns insurance fraud tends to increase. There are national as well as international expenditure efforts to enhance methods to combat insurance fraud. In a survey, private passenger auto and workers compensation were considered by surveyed insurance companies as the two lines of insurance subject to the most fraud. Companies ranked seriousness of insurance fraud at 4.3 in a scale of 1 to 5 (17). Automobile insurance fraud represents one of the insurance industry's greatest challenges and is responsible in large part for a tense and tenuous relationship between many insurers and the public. The National Auto Theft Bureau estimates that 15% of all vehicle theft reports are fraudulent. Auto insurance fraud is the largest and fastest growing segment of insurance fraud, and the cost of all fraudulent automobile claims account for 15 to 20% of auto insurance premiums (or 25 to 33% of total claims expenditures).

Insurance socialization: many past and present government regulations enforce schemes to have low-risk insureds subsidize high-risk insureds through both compulsory as Social Security, and voluntary insurance as regulated compression of rate differences among different risk classes. Experience shows that “Efforts by both public and private organizations to socialize insurance prices have, by and large, been undermined because the insureds most heavily penalized eventually found ways to avoid subsidizing higher risks . . . . Unless government precludes any market driven insurance arrangement, the only means by which government can effectively impose socialized premiums without creating severe market distortions is through compulsory participation in a program like Social Security . . . . Legislators must understand that market forces in voluntary insurance markets will lead to some form of risk-based differentiation among insureds. In other words, efforts to provide legislated ‘rate relief’ to certain groups will, sooner or later, fall short of their goals and have other undesirable effects” (2).

Insurance redlining: a common practice of refusing to write an insurance product or varying the terms of an insurance product because of the geographical location of the property and because of the racial or ethnic composition of the area. Insurance redlining is one manifestation of discrimination in the provision of housing related insurance. There are also more general forms of discrimination in housing-related insurance, including the unequal treatment in the provision or terms of insurance, based on race, color, religion, national origin, sex, handicap or familial status. Both forms violate the Fair Housing Act.

In 1968 the President's National Advisory Panel on Insurance in Riot Affected Areas said: “Insurance is essential to revitalize our cities . . . without insurance, banks and other financial institutions will not and cannot make loans . . . new housing cannot be repaired . . . efforts to rebuild our nation's inner cities cannot move forward. Communities without insurance are communities without hope”(18). Looks like a today's description.

Self Insurance: It is a mirror reflection of current art broader insurance practices, that generally speaking impose a burden rather than a solution to most self insured entities. In recent years, changes in law, claims handling, managed health care and computers have changed the economics of self insuring versus insuring liabilities. Numerous public and private entities are reviewing the cost and effectiveness of their current insurance and self insurance programs. In many states, private insurers have historically been prohibited from writing insurance coverage for public entities. These prohibitions most often applied to workers compensation coverage. Recently several states have changed these laws, allowing many public entities to choose between self insurance and private coverage for the first time. Clients switching from self insurance to insurance typically require a large additional amount of cash in the first years of insurance. Completely paying off old self insured liabilities takes years, from a low of 3-4 years for property liability, to as much as 60 years for workers compensation. During this 3 to 60 year period, the client is paying for both insurance premiums and old self insured losses. For many clients, particularly public entities with tight budgets, short term cash flow constraints have prevented moving to an insured program which is much less expensive in the long run. Carrier premium financing beyond three years is rare. Though many claims will take over 10 years to pay completely, no carrier-sponsored premium financing lasts that long (19).

Preexistent health problems: generally speaking any individual either born with or getting a disease later in life find it extremely difficult and very expensive to get healthcare coverage both for the preexisting and other risks.

### SUMMARY OF THE INVENTION

The amount of $1,020,631 (average $17,010 a year during 60 years) mentioned above is quite an amount to spend. With the invention many caring and prudent or just lucky people might be able to keep all or most of that valuable fund in their pockets while being risk covered.

Why keep only spending insurance premiums if information technology enables today instant, interactive, transparent trading of obligations to cover a certain risk and eventually exchange it to have a different risk covered for the same money.

Some obligations that may be traded with the invention are: any means of transportation hardware and it's related parts and manpower; existent or developing drugs; every single medical or dental output; any therapeutic service, instrument or aid; any home or office, personal or business hardware and software; any home, building and construction parts and it's related manpower; apparel for personal or business use; musical instruments; law practice services; any industrial machinery; any liability; etc. In short any life or non life risk.

An individual consumer may buy an obligation for a car valued in $20,000 from a supplier like Honda or General Motors, to cover the risk involved in the event of an accident resulting in loss of the vehicle in use. The obligation may also be purchased just for certain generic parts or certain money amount for generic parts of a similar vehicle to cover replacement and manpower in case of accident. The consumer may not need the obligation for himself and be ready to give it to another person due to liability involved in the accident, or purchase an obligation covering more value in whole or parts to extend liability for physical damage to someone else's vehicle. If there's a need an obligation may be purchased or swapped in the trading floor to get a specific output to cover compensation.

The same procedure is valid for every single other output a consumer might need to cover a risk. If the event does not occur as many will, the beneficiary keeps the value as a saving. A fund that may eventually replace a current art Long Term Care, Term Life insurance, or complement uncertain Social Security benefits (20), etc.

If many events will not happen, consumers may pool for instance the current price of a given obligation among two or more members in a group such that in case of the event arising to one of the members the consumer pool purchased obligation is entitled to that member as beneficiary, ending thus the group commitment caused by event occurrence.

This last aspect of the invention is relevant to provide consumers with budget price in their needs for expensive obligations like organ transplants, liability, catastrophe and any major risks.

Being the consumer for instance a group of individuals or employers, constituted after actuarial data guidelines on event occurrence and members' profile to minimize risk, the price of the obligation purchased splits in as many fractions of value as members exist in the group. Actuarial data is able to show the risk of same event arising for instance to 1 every 20 individuals. In this case consumers purchasing an obligation of $10,000 for a 20 members group will enable a group member to pay or loan only $500 and eventually close his life-span expenditure to cover the risk involved. If additional risk minimization is wanted, then the same obligation might be split in a 10 or 5 members group where each member will pay or loan $1,000 or $2,000 respectively.

An automobile or professional liability risk covering the amount of $200,000 may be split in a 200 members group (or proper actuarial optimum) paying each member $1,000 to entrust the total amount to a supplier (financial institution) willing to accept the obligation and to pay interest or safely invest the fund, until the event occurs and a beneficiary is entitled. Participation in various pooled obligations should further minimize risk to any prudent consumer.

| 5 most expensive hospital | | 5 most expensive | | 5 top reasons | Nr. of |
|---|---|---|---|---|---|
| procedures | | hospital diagnoses | | for admission | Admissions |
| Heart, lung, | $191,000 | Spinal Cord | $56,800 | Infant birth | 3.8 million |
| pancreas and | | injury | | (liveborn) | |
| liver | | | | | |
| transplantation | | | | | |
| Thracheostomy | $148,000 | Infant | $56,600 | Coronary | 1.4 million |
| | | respirator | | atheroscierosis | |
| | | y distress | | | |
| | | syndrome | | | |
| Bone marrow | $137,000 | Low | $50,300 | Pneumonia | 1.2 million |
| transplantation | | birthweight | | | |
| Kidney | $66,000 | Leukemia | $46,700 | Congestive | 990,000 |
| transplantation | | | | heart | |
| | | | | failure | |
| Heart valve | $66,000 | Heart | $45,300 | Heart attack | 744,000 |
| procedures | | valve | | | |
| | | disorders | | | |

The precedent tabled information tells a few things about the proper health coverage a person may need. For instance it might be wiser to be group covered for the dearest procedures like heart or lung transplantation and individually covered for the five top reasons for admission like childbirth or heart attack.

If the actuarial information tells that one every x persons need heart or lung transplantations a consumer may participate in a group with x persons to split that obligation price, and also purchase an individual “short gestation/low birth weight/fetal growth retardation” obligation for $16,053, or a “coronary arthery bypass graft” obligation for $44,304. The supplier, to attract consumers, may be even willing to bind use by the beneficiary of any output priced lower than the individual consumer's obligations purchased, either by same supplier or by alternative suppliers networked for that purpose, widening thus the output scope of the obligation. Allowing the beneficiary to get for instance a “liveborn” output for $4,043 or a “percutaneous transluminal coronary angioplasty” for $19,255 as partial output cancellations of the comprehensive dearer obligations (21). Group obligations will further induce community awareness. Interracial strengths through a mix of genetic and cultural imprints may allow grouped consumers to diversify risks and narrow exposure.

Furthermore in the trading floor consumers will be able to swap an obligation covering for instance private vehicle output for other covering medical output.

Should the event not happen the obligation value turns into a saving or financial asset and eventually into a profitable investment since at least past inflation will be part of the updated market price of the obligation. With no limits to group formation consequently there are no limits to the scope and number of pooled obligations in which any given consumer might participate. At his will any group member may recover the value paid selling or swapping the obligation's share while it's still an option, before event occurs.

Existing insurance companies, as investors, can buy obligations from suppliers as a convenient dual utility way to cover risks precluding output price rises or portfolio diversification investment.

### BRIEF SUMMARY OF THE INVENTION

Considering the current known art of insurance, the invention will provide useful, concrete and tangible results and solve some serious and extensive problems including the above mentioned. Some of the solutions are:

Obligations, until cancellation out of need, are a one shot deal to cover risk without additional payments. Consumers may have cost predictability at the beginning of the transaction. Current art insurance practice, with premium price fixation only for the contracting period, implies an open end since many insurance premiums have to be paid for a lifetime with future price variables unknown at the moment of first transaction. Healthcare obligations for employees, retirees and enrollees may preclude any future price rises. A combination with a pretax dollars health savings account like Medical Savings Accounts would facilitate direct payment for qualified and routine healthcare expenses.

Beneficiaries loosing their jobs will not face temporary gaps in healthcare and other risks coverage. The beneficiary since inception will be individually entitled to the obligation. Although employer paid, current healthcare premiums come out of workers wages (22).

A natural market driven interest will keep suppliers and beneficiaries away from current art extensive fraud practices since obligations output may be claimed only after paying or loaning the full price. Group obligations event occurrence will surely have close members' audit.

Higher-risk consumers like the ones involved in hazardous jobs, professional or amateur sports, unsafe locations, etc., will not pay price differentials for similar obligations purchased by lower-risk consumers. They may only experience, if negligent or unlucky, a more frequent use of obligations. No socialization regulations will be needed.

Any form of insurance discrimination or redlining would be useless with the invention.

Self Insurance should not constitute a problem since the invention opens the way to self compensate eventual loss sensitively reducing current art expenditure. Furthermore suppliers will be actively willing to adequately finance any large purchase of obligations by private or public entities.

Beneficiaries will tend to save obligations, developing an aggregated market driven interest, e.g., to drive safely or avoid health hazards. Using obligations will mean consuming a saving that otherwise might be kept as a relevant personal fund.

The invention gives small businesses and self employed, if uninsured, a convenient and affordable risk protection.

Consumers with preexisting health problems, who in current art often cannot buy insurance to cover preexistent and other health risks, will be able to do it.

Reselling the obligation may result in a price gain beyond inflation since “state of the art” output update will be a must for suppliers willing to raise funds.

Consumers may benefit at large with pending individual or group obligations. This reason will trigger quite probably less claims for suppliers' output. A reversion of current art insurance escalating claims and compensations process.

Funds raised by suppliers will be in payment for output, the underlying enforceable asset. In other words a securitization of funds raised by selling obligations. Obviously an alluring gate to interest free financing that will keep suppliers away from uncompetitive practices.

The same market driven stimulus will persuade suppliers not to perform useless, unnecessary or inadequate output in exchange for funds raised.

Many intermediate steps may be eliminated with respect to current art practice eventually reducing total risk coverage expenditure for similar output.

Enriching current insurance art the invention will further induce efficient allocation and optimization of resources for both consumers and suppliers.

It seems convenient to emphasize that—again through market driven stimuli, not costly government intervention—, for both consumers and suppliers alike, the invention, making you pay for your sins, broadly solves the remaining, less obvious, insurance “market failures”: adverse selection and moral hazard.

Furthermore what is labeled as “social insurance”, comprising particularly retirement income and health care, is an escalating problem in OECD countries with expenditures eating up half of total government budgets and accounting for between a sixth and a third of GDP (23). Current art insurance premium expenditures (average $1,020,000 lifetime as we have shown, with the invention method, miiht well be kept—at least partially—by the consumer/beneficiary as an invested saving, allowing a sensitive reduction of taxpayers contribution to social security and cooling political pressures mounting out of the need to care for aging populations.

### BRIEF DESCRIPTION OF THE DRAWINGS

Drawing 1 is a block diagram showing the system of the present invention.

Drawing 2 is a flowchart showing the method of the present invention.

### DETAILED DESCRIPTION OF THE INVENTION

The description given herein is for exemplary purposes only and is not intended in any way to limit the scope of the invention.

The invention can be implemented in any suitable manner, including completely manually, by manual operation of electronic or mechanical data, or completely automatically. Preferably a method performed automatically through electronic means using a computer network being this preferably the Internet through the World Wide Web.

The Internet, after the printing press, is such a breakthrough in information distribution technology that allows not only the usual virtual extrapolation of existing means and ways to conduct business, but also new ideas to further enable community choice as in the invention. Data instant global distribution and most of all mass interactivity and hypertext constitute perhaps the main leap forward of Internet with respect to previous technologies.

The invention may benefit most from the use of Internet. Availability of cheap and huge interactive data capacity is a relevant tool for optimizing the invention mode. World Wide Web platforms are reliable mass marketing means to trade financial instruments, like obligations, among consumers and suppliers, as are cheap and mass accessible Internet communication means like formularies, e-mail, chat and message boards.

The invention uses an Internet platform trading floor that adequately enables data exchange and transactions involving consumers and suppliers. The platform structures itself with programming strings containing computer data arrangements to further provide, inter alia, technical effects as follows:

i. access to multiple suppliers willing to sell obligations to cover deferred output;

ii. access to multiple consumers willing to buy obligations to cover deferred events' loss;

iii. transparent marketplace to complement or substitute current insurance art coverage;

iv. choice prevalence;

v. one-stop unbiased comparison shopping;

vi. supplier-sponsored retail and wholesale obligations quotes;

vii. privacy, and encryption coding to conclude business among willing participants;

viii. competitive data design to offer, demand, buy, sell and swap obligations;

ix. supplier to consumer, consumer to consumer and supplier to supplier services;

x. suppliers national and international network, including same industry suppliers to cover similar risk and range of industries suppliers willing to cover different risks in consolidated output combinations;

xi. output clearing house in which beneficiaries may select a networked supplier to claim output independently of who was the original contracting supplier;

xii. obligations' trading as a valuable new source of portfolio diversification for investors.

The obligations of suppliers may have any suitable legally binding form and be backed by any suitable legally binding means agreed upon by supplier and consumer in accordance with any government agency regulations applicable. Consumers and suppliers may directly transact individual or pool business deals.

Group purchase of obligations have standards (e.g. actuarial) to adequately serve the interests of group members. Applicants profiles, from Individual Reference Services with due respect for privacy, are available in the trading floor for consideration by other potential members as one of the previous steps for pool purchase of any obligation.

For liability coverage (auto, professional, etc.) and any other money output obligation, group members pooled money may be entrusted to a participating qualified supplier like a financial institution and bear interest or earn income from investment.

The group selects a coordinator member to interact with the trading floor and perform any representation tasks involving for instance receiving immediate notification of event occurrence by a group member to avoid loosing entitlement, or evaluating if a candidate profile meets appropriate standards when a group member is willing to sell or swap participation in the obligation. In money output obligations representation may be exercised by the participating supplier entrusted with the funds.

Output securitization is the outcome of customers' acquisition of the options contained in obligations. Further elaborated it can certainly pave the way to facilitate additional risk protection choice to consumers. Businesses like insurance companies and large consumers may cover targeted risks with obligations purchased to satisfy their needs or simply as a dual utility portfolio diversification for their investment hedging. Investors may buy obligations as a portfolio diversification for later own use or reselling. Trading floor arrangements will allow consumers to operate what's called in financial markets “call options” and “put options” advancing to willing suppliers a small downpayment of the obligations' total price.

Consumers and suppliers interests will be best served with the invention's development of, inter alia, the following trading stimuli:

i) sound financial and quality ratings of suppliers;

ii) no need to probe event occurrence to suppliers prior to output claim;

iii) transparent supply information with no sales pressure;

iv) adequate obligations trade or swap in a transparent marketplace;

v) instant replacement for cancelled obligations;

vi) statistics on actuarial expectations of obligations saving;

vii) obligations and output clearing in a national/international network of suppliers;

viii) scope of suppliers' output offered for same obligation;

ix) convenient voluntary group forming and functioning regulations;

x) accessible actuarial data on obligations risks coverage;

xi) suppliers collateral as for instance output secured bonds;

xii) partial cancellation of individual and eventually group obligations;

xiii) quality comparisons among similar obligation offers;

xiv) suppliers binding to “state of the art” technological output updating at time of claim;

xv) obligations' installments payment, with or without intermediary's loan;

xvi) individual entitlement of obligations paid by third parties;

xvii) employers' tax-deducted health care spending under existing tax laws;

xviii) legal counseling to consumers;

xix) alternative dispute settlement procedures servicing suppliers and consumers;

xx) availability of obligations' call and put options.

As can be appreciated in drawing Nr. 1 access granted suppliers (105) and consumers (103) will be able to input and retrieve supply (102) and demand (101) information in the trading floor (117) through their computers (107, 108) and Internet's service providers (115).

Consumers may be single (or grouped) individuals (109), employers (111), legal entities (both private and public, 113) and government agencies (114). They naturally constitute the demand side since obligations' output beneficiaries (106) will normally come from among them. Investors (118) may join the demand side to diversify their portfolios or preclude output price rises.

Single or grouped goods manufacturers (110) and service providers (112) are the suppliers (105) and constitute the backbone of the supply (102) side. They raise interest free funds when selling the obligations and they are bound to satisfy output claims. Consumers (116) willing to resell or swap obligations may also join the supply side.

The marketplace (117) will give access to due actuarial data, complementing data provided by sponsoring suppliers (e.g. output retail and wholesale quotes), consumers (e.g. output retail and wholesale demand) and investors, and enable quality and price comparison.

Ratings of suppliers, regarding financial strength and output quality will be made available (117) to consumers. Additionally the trading floor (117) will build a public access database scoring total obligations transacted, identifying suppliers and eventually willing consumers, and suppliers output compliance.

Profiler data regarding specific output may be reached by consumers willing to participate in group obligation purchasing and be included in a database for mutual contact (117).

Suppliers networked for offers and/or bound in output clearing (117) will be singled out for consumers evaluation. Suppliers will be stimulated to network themselves in a national and international level to attract consumers by facilitating choice in beneficiaries' future output claims. Naturally the network will be served by a clearing house able to transfer updated payment from the original contracting supplier to the networked output delivering supplier.

Suppliers selling and consumers reselling or swapping pending obligations and consumers willing to buy, will eventually contact each other by trading floor means, e-mail, chat, telephone or personally.

They may study the obligations with the options contained. May compare different suppliers' similar obligations, may consider retail prices or wholesale prices for group purchase. May contact other candidates interested in group purchase, having mutually evaluated profiles, and eventually consolidate the group.

They may further a transaction directly, using or not trading floor available means, and conclude contract formalities and later notify the outcome to the trading floor to have the obligation dully registered for statistical purposes and eventually for having the trading floor as an alternative dispute settlement arbiter in output claims between the beneficiary and the original or the chosen supplier.

As drawing Nr. 2 shows a consumer (202) may access, through a computer and Internet service provider (203), the invention's trading floor (204).

After evaluation of the existing offers or the offers received after a demand request, an obligation is selected (205).

If the consumer is willing to purchase an individual obligation (206), evaluating a supplier is the next step. A supplier selection follows (209).

If the consumer needs a group obligation (208) then a search of existing applicants is initiated or a participation request is posted for establishing the group. The newly established group may then select a supplier (209).

The following step consists in the contractual formalization (210) of the obligation between the supplier and the consumer.

As a holder of the obligation the consumer may resell or swap (211) the obligation or corresponding share at will.

If event occurs and results in loss (212) the consumer/beneficiary, holding an individual obligation, may claim output (214) to the contracting supplier (217) or, if available, the chosen networked supplier (216).

If the loss needs different output than the obligation purchased, being an individual obligation it may still be conveniently resold or swapped (213).

An investor may resell or swap (213) obligations anytime as well as entitle (215) the obligation at will if need be.

If event occurs to a group obligation member (208), formal entitlement (215) of output shall be given by the group. When this step is concluded the member can claim output (214) to the contracting supplier (217) or choose a networked supplier (216) if available. Event occurrence naturally precludes reselling or swapping the group obligation or it's shares.

If either an individual or group obligation beneficiary chooses output from a networked supplier (216), different from the original contracting supplier (217), claim may be made only after the clearing house (218) makes the necessary payment arrangements.

Eventually the trading floor may act as arbiter upon consumer and/or supplier request for any dispute settlement (219).

Output fulfillment by supplier takes place.

References

(1) “The History of Insurance”, David Jenkins and Takau Yoneyama, Pickering & Catto publishers, London. Bureau of the Census, Finance and Insurance Statistics.

(2) “Attempts to socialize insurance costs in voluntary insurance markets: the historical record”, Bartlett, Klein, Russell, Georgia State University, footnotes pages 5, 7, and Conclusions.

(3) Bureau of the Census International Brief “Gender and Aging”, October 1998. National Vital Statistics Reports, Jun. 30, 1999.

(4) California Department of Insurance.

(5) www.insweb.com

(6) Paper published by the Federal Reserve Board “The Geography of Medicare”, by Louise Shiner and David Cutler.

(7) www.myagency.com

(8) KPGM Peat Marwick “Health Benefits in 1994”.

(9) “Market Driven Health Care . . . ”, Regina Hertzlinger, Harvard Business School, May 1998, p. 281.

(10) “Patient Power: the Cato Institute's Plan for Healthcare Reform”, by Brink Lindsey, 1993.

(11) “National Health Expenditure, 1999”, Health Care Financing Review, Summer 2001.

(12) “National Health Expenditure Protections 1994-2005”, Health Care Financing Review, Summer1995.

(13) Health Care Financing Administration, Office of the Actuary, data from the Office of National Health Statistics.

(14) Bureau of Labor Statistics, Consumer Expenditure Survey.

(15) Aragon Consulting Group “What Americans Think”, 1996.

(16) Census Bureau “Health Insurance Coverage in the U.S. The new Census Bureau Numbers for 2000 and the Trend into 2001. A brief analysis from the National Institute for Health Care Management Foundation”, Sep. 26, 2001.

(17) National Insurance Crime Bureau; “insurers believe insurance fraud is a serious problem despite their companies efforts to fight it”, Research Report by Insurance Services Office and Insurance Research Council; The International Association of Insurance Fraud Agencies, Inc.

(18) Sarah Pratt's Sep. 12, 1997, presentation at the John Marshall Law School's Conference on Mortgage Discrimination and Insurance Redlining. (19) U.S. Pat. No. 6,009,402. Whitworth, Brian.

(20) In two important cases, Helvering v. Davis and Flemming v. Nestor, the U.S. Supreme Court ruled that Social Security taxes are simply taxes and convey no property or contractual rights to Social Security benefits. As a result, a worker's retirement security is entirely dependent on the political decisions of the president and Congress. Benefits may be reduced or even eliminated at any time.

(21) “Most Common Diagnoses and Procedures in U.S. Community Hospitals”, 1996. Health Care Cost and Utilization Project, HCUP Research Note, Agency for Healthcare Research and Quality.

(22). “Pooling Health Insurance Risks”, by Mark Pauly and Bradley Herring, December 1999.

(23) “Privatizing peace of mind”, The Economist, print edition, Oct. 22^{nd}, 1998.

I claim:

1. A data processing system and method, preferably computer related, comprising a consumer, single or grouped, paying for an obligation to a selected supplier, single or grouped, in order to cover partial or full compensation for any insurable risks' eventual loss, in such a way that if the event does not happen the obligation is kept by the consumer/beneficiary as a saving.

2. A system and method as set forth in claim 1 including the steps to provide consumers risk coverage linked to market driven stimuli eliminating the so called “market failures” congenital to prior art insurance system and method.

3. A system and method as set forth in claim 1 including the steps to provide suppliers with interest free financing through the sale of obligations comprising inherent deferred output deliverable upon claim by a beneficiary.

4. A system and method as set forth in claims 1, 2 and 3 comprising steps to allow risk population consumers (e.g. preexistent health problems, hazardous jobs, etc.) to get individual and/or group coverage obligations on the same conditions of price and quality as non risk consumers.

5. A method as set forth in claims 1, 2, 3 and 4 including the steps of providing both supplier and consumer/beneficiary access to a site on a computer network.

6. A method as set forth in claim 5 wherein the computer network is the Internet.

7. A method as set forth in claims 5 and 6 comprising the steps to enable:
a supplier—single or grouped—to:
sell obligations
a consumer/beneficiary—single or grouped—to:
buy obligations
trade obligations
swap obligations.

8. A method as set forth in claims 6 and 7 comprising the computing functions steps to provide participants a virtual trading floor performing data processing and technical effects necessary to:
evaluate potential transactions
select potential transactions
conclude selected transactions

9. A method as set forth in claim 8 comprising the data processing and technical effects steps to organize obligations order-matching and/or principal market making.

10. A method as set forth in claim 8 comprising the data processing and technical effects steps to:
inform consumers about existing suppliers' offer
inform suppliers about requested consumers' demand.

11. A method as set forth in claim 8 comprising the data processing and technical effects steps to enable consumers to evaluate suppliers.

12. A method as set forth in claim 8 comprising the data processing and technical effects steps to assist consumer's searching shareholders to buy obligations in shareholding groups.

13. A method as set forth in claim 8 comprising the data processing and technical effects steps to deliver actuarial data according to the needs of both consumers and suppliers.

14. A method as set forth in claim 8 comprising the data processing and technical effects steps to:
formalize contracts to buy/sell obligations
formalize contracts to resell obligations
formalize contracts to swap obligations

15. A method as set forth in claim 8 comprising the data processing and technical effects steps to:
create and organize consumers' national networks
create and organize consumers' regional networks
create and organize consumers' international networks.

16. A method as set forth in claim 8 comprising the data processing and technical effects steps to:
create and organize suppliers' national networks
create and organize suppliers' regional networks
create and organize suppliers' international networks.

17. A method as set forth in claim 8 comprising the data processing and technical effects steps to securitize obligations.

18. A method as set forth in claim 8 comprising the data processing and technical effects steps to entitle groups' beneficiary or beneficiaries in case of event occurrence.

19. A method as set forth in claim 8 comprising the data processing and technical effects steps to fulfill payment clearance among networked suppliers.

20. A method as set forth in claim 8 comprising the data processing and technical effects steps to:
monitor output fulfillment
eventually arbitrage dispute settlement upon consenting parties request
